(19) United States
(12) Patent Application Publication
(10) Pub. No.: US 2021/0222488 A1
(43) Pub. Date: Jul. 22, 2021

(54) Non-stay-cord venetian blind and winding device thereof

(71) Applicants: Zhejiang Hongding Industrial Co., Ltd, Taizhou,Zhejiang (CN); Lantex Window Fashions Co., Ltd, Jiaxing, Zhejiang (CN)

(72) Inventors: Zhijun Lin, Taizhou,Zhejiang (CN); Jianming Yu, Jiaxing, Zhejiang (CN)

(21) Appl. No.: 16/097,790

(22) PCT Filed: Aug. 30, 2017
(86) PCT No.: PCT/CN2017/099733

§ 371 Date: Oct. 30, 2018

(30) Foreign Application Priority Data
May 3, 2017 (CN) 201710305870.3

(51) Int. Cl. E06B 9/322; E06B 9/303

(52) U.S. Cl. CPC E06B 9/322; E06B 2009/3225; E06B 2009/3222; E06B 9/303

(57) ABSTRACT

A winding device for a non-stay-cord venetian blind is disclosed, which comprises a fixing seat, a fixer, winding drums with one-way dampers, a rear cover and iron cores. A non-stay-cord venetian blind adopting the winding device is also disclosed, which comprises a top beam, a bottom beam, slats, cords, a winding device, a motor and a shaft. The winding device adopts a unique separate settlement for the motor, which is convenient for mounting and displacement and easy to roll up and down. During the operation, the non-stay-cord venetian blind keeps horizontal and the bottom beam does not slide down or bounce back in any positions. The winding device is able to be applied on blinds adopt strip or string shaped ladder tape or blinds with center holes, side holes or side slots on the slats. Multiple cords are able to be winded the same winding drum.

### CROSS REFERENCE OF RELATED APPLICATION

This is a U.S. National Stage under 35 U.S.C 371 of the International Application PCT/CN2017/099733, filed Aug. 30, 2017, which claims priority under 35 U.S.C. 119(a-d) to CN 2017103058703, filed May 3, 2017.

### BACKGROUND OF THE PRESENT INVENTION

### Field of Invention

The present invention relates to a venetian blind, and more particularly to a non-stay-cord venetian blind.

### Description of Related Arts

The venetian blind is made up of multiple slats which are connected and folded together. The venetian blind is not only able to assist ventilation, shade the sunlight, and lower the temperature but also for soundproof and decoration. The venetian blind is mounted inside or on the top of the window and moves between the open position and the close position. When the venetian blind is in the open position, the light is able to enter and people are able to see through the window. When the venetian blind is the close position, light is barely able to enter and people are not able to see through the window. The conventional venetian blind is made up of multiple long and horizontal slats. The length of the slats is decided by the size of the window. The slats of a conventional venetian blind are connected to a vertical axis. All the slats rotate around the common mounting axis when the vertical axis is moved along a vertical direction. When the vertical axis moves along the vertical direction, all the slats are spaced out and in an almost horizontal position. When the vertical axis moves in a reversed direction, all the slats are overlapped and in an almost vertical position. The light is able to enter through the slats when the slats are in the horizontal position. The slats block out most of the light when are overlapped and in a vertical position. The space between the two neighboring slats is smaller than width of the slat so that the slats are able to be overlapped and closed.

The Chinese patent CN10521049A (public date: Jan. 6, 2016) disclosed a conventional venetian blind which comprises slats with holes, cloth ladder tapes with cross stripes, lifting circulating stay cords with plumb handle, lifting belts, a top beam assembly system and a bottom beam; wherein the top beam assembly system comprises a top beam on one end of which a lifting brake head is mounted. A side cover is mounted on the other end of the top beam. An iron bar shaft is assembled inside the top beam assembly system; wherein one end of the iron bar shaft is mounted in the lifting brake head and the other end is inserted in a resistance-free winder assembly corresponding to the holes on the slats of the venetian blind. The iron bar shaft is assembled with the lifting winder reel of the resistance-free wider assembly and the angle turning mechanism of the cloth ladder tape. The cords of the conventional venetian blinds are outside of the curtain body which may cause dangerous for kids. The manually controlled cords may be damaged due to different force applied on by the user and different directions of the force and reduce the service time of the venetian blind.

The Chinese patent CN101426998 disclosed an automatic control device of the venetian blind which comprises slats share a common hinge. The automatic control device comprises a motor and slat slots for connecting the body and connection part; wherein on the connection part there are structures in a shape at least partly matches one end of the slat and are for the slat to connect to. The control device further comprises a mobile assembly for the slat slots to move between the first position and the second position; wherein the mobile assembly is driven by a motor and may be connected to the slat slots.

### SUMMARY OF THE PRESENT INVENTION

An object of the present invention is to provide a new non-stay-cord venetian blind. The cords of the venetian blind are installed inside, which avoids the safety problem. The winding device and the motor in the present invention is separately assembled, which is convenient for replacement and extends the service time of the venetian blind. The present invention adopts a fixing seat structure which is suitable for both strip-shaped ladder tape and string-shaped ladder tape and is able to be applied for multiple ladder tapes. The winding device of the present invention utilizes the cords friction to keep the venetian blind maintaining in different positions and prevent the venetian blind from sliding down or bounce back. The motor in the present invention adopts an assembled structure which uses clippers. A fixing bracket is adopted to fix the motor shell, the spiral spring, the big roller and the small roller in an integrated way. The assembled structure is easy to assemble and maintain compared to the welding assembly.

The present invention provides a winding device for the non-stay-cord venetian blind. The winding device comprises a fixing seat, a fixer, winding drums (71), a rear cover and iron cores, wherein each of the winding drums comprise a one-way clutch damper which enables the winding drum to roll up and down the venetian blind independently. The winding drum of the present invention comprises the one-way clutch damper which enables the winding drum to roll up and down the venetian blind independently. Thus the winding drum and the motor are able to be mounted separately, which is convenient for assemble and enables the replacement of the worn-out winding drum and motor separately. The production and consuming cost are reduced. Multiple winding drums are able to be mounted on the curtain and share a common motor, which is easy to assemble and reduces the production cost.

Preferably, the one-way clutch damper damps in a way selected from the group consisting of a rubber damping, a plastic damping, a damping tape, a spring and a tight fit. The conventional dampers are able to be applied in the present invention. The rubber damping, the plastic damping, the spring or the tight fit are preferred choice; wherein the elastic rubber and the clamping spring are preferred.

The one-way clutch damper further comprises a clamping spring, a center one-way shaft and steel balls. The clamping spring is for the one-way clutch damper damps the system. Preferably, a first end of the clamping spring is tight fitted on a center one-way shaft; a stop clamp is on a second end of the clamping spring; on the fixing seat there is a groove for the stop clamp; the clamping spring and the stop clamp (760) are clamped and fixed in the groove. When there is no external force applied on the venetian blind, the weight of the bottom beam and the slats drag the venetian blind downward. The resistance of the clamping spring overcomes the gravity and stops the rotation of the center one-way shaft. The venetian blind remains still.

Preferably, the center one-way shaft is put on a first end of each of winding drum cavities; the center one-way shaft (75) is clearance fitted with the winding drum cavities. On a surface of the center one-way shaft there is a rail for restricting a steel ball sliding. There is a sliding rail on the winding drum cavities. Preferably, a first end of the winding drum comprises the center shaft. The sliding rail is set between the center shaft and the inner wall of the winding drum cavities. The center one-way shaft is mounted on the center shaft inside the winding drum cavities. The clearance between the center one-way shaft and the sliding rail on the winding drum is the space for the steel balls to roll. The second end of the winding drum is connected to the rear cover.

Preferably, on the surface of the center one-way shaft there is a rail for restricting a steel ball sliding. There is a sliding rail on the winding drum cavities. The steel balls are between the center one-way shaft and the winding drum cavities; movements of the steel balls are limited within an area formed by the rail for restricting the steel ball sliding on the surface of the center one-way shaft and the winding drum cavities. The steel balls, center one-way shaft and the winding drum constitute the one-way clutch damper. When the venetian blind is rolled up under the external force, the winding drum drive the steel balls to slide on the rail for restricting the steel ball sliding, which enables the winding drum to rotate independently of the center one-way shaft. The bottom beam stops in any position when there is no external force. The weight of the bottom beam and the slats drag the venetian blind downward and the venetian blind tends to roll down. The winding drum tends to rotates downward with the steel balls which are not able to slide in the rail for restricting the steel ball sliding. The winding drum, the steel balls and the center one-way shaft tend to rotate together. The resistance of the clamping spring stops the center one-way shaft from rotating, which keeps the venetian blind remains still. Under the external force, the steel balls in the winding drum overcome the resistance of the clamping spring and drive the center one-way shaft to rotate, which rolls down the venetian blind smoothly. The rail for restricting the steel ball sliding is preferably a rail distributed on the surface of the center one-way shaft, which is preferably a groove or a through hole.

Preferably, there are a cord center hole, ladder tape holes and fixing slot for the iron cores on the fixing seat.

Preferably, the cord center hole is on the center of the bottom of the fixing seat and passes through the bottom of the fixing seat.

Preferably, the ladder tape holes are on the two sides of the cord center holes and passes through the bottom of the fixing seat. Preferably, there are two ladder tape holes through which the ladder tapes or the cords passes through. Two cords are able to pass through the ladder tape holes when the cords are distributed on the two sides of the slat.

Preferably, the ladder tape holes are in a strip shape, which are suitable for the strip-shaped ladder tape and the string-shaped ladder tape. The ladder tape holes are suitable for both the wide ladder tape and the narrow ladder tape.

Preferably, on two sides of the fixing seat there are cord holes on which the iron cores are located. The iron cores are mounted in the fixing slot to damp the system. Preferably, there are two iron cores and two fixing slots on each side of fixing seat.

A non-stay-cord venetian blind comprises a top beam, a bottom beam, slats, cords, winding device, motor and shaft, which adopts the winding device in the present invention. The non-stay-cord venetian blind is able to be the strip-shaped ladder tape venetian blind, the string shaped ladder tape venetian blind or venetian blind with center holes, side holes or side slots on the slats. Multiple cords are able to be winded on the winding drum. Preferably, the motor comprises the shell, the spiral spring and the rollers.

Preferably, the rollers comprise the big rollers and the small rollers.

Preferably, the shell comprises a first side shell and a second side shell; on the first side shell there are roller slots or through holes for the small roller and the big roller and a first clipper set for the second side shell; on the second side shell there are roller slots or through holes for the small roller and the big roller and a second clipper set for the first side shell. The first clipper set matches the second clipper set, which assembles the first side shell and the second side shell.

Preferably, on a roller slot for the big roller there is a spiral spring slot. The spiral spring is put on the small roller. A clamping hook is on an outer end of the spiral spring, which is clamped and fixed inside the spiral spring slot.

Preferably, the spiral spring between the big roller and the small roller is in a S shape. The spiral spring is coiled inside the small roller while the venetian blind rolling up and the spiral spring is coiled inside the big roller while the venetian blind rolling down.

Preferably, the motor further comprises a fixing bracket which comprises a shell connection part. The fixing bracket fixes the spiral spring and the rollers.

Preferably, the shell connection part is connected to and assembled with the first side shell and/or the second side shell by clippers. The clippers connect and fix the fixing bracket and the shell.

Preferably, on the shell connection part there are dents or convexes match the first side shell and/or the second side shell. The dents or convexes are for connecting and fixing the fixing bracket and the shell.

Preferably, on the first side shell and/or the second side shell there are dents or convexes match the shell connection part. The dents or convexes are for connecting and fixing the fixing bracket and the shell.

Preferably, the cords are installed inside the non-stay-cord venetian blind. Preferably, holes are punched on the slats, through which the cords pass.

Preferably, a first end of the cords is fixed on an end of each of the winding drums near the rear cover; a second end of the cords crosses and passes through the iron cores on a side of the fixing seat before passes through the cord center hole on the bottom of the fixing seat and all the slats. The cords are fixed on the bottom beam. The winding device is connected to the motor by the shaft which enables a synchronized rotation of all rollers.

Preferably, center holes are punched on the slats, through which the cords pass.

Preferably, there are two cords are winded and fixed on the winding drums.

Preferably, there are two center holes on each of the slats; there are two winding drums corresponding to the two center holes on each of the slats; there are two cords and each of the cords passes through the center holes on the slats before is winded and fixed on a winding drum on a same side.

Preferably, side slots or side holes are punched on the slats; wherein the cords pass through the side slots of the side holes on the slats.

Preferably, there are at least two cords.

Preferably, there are two winding drums corresponding to the side slots or side holes; wherein each of the cords passes through the side slots of the side holes before is winded and fixed on a winding drum on a same side.

Preferably, the venetian blind does not comprise cords outside of the non-stay-cord venetian blind.

A non-stay-cord venetian blind is disclosed in the present invention. The winding device adopts a unique separate settlement for the motor, which is convenient for mounting and displacement and easy to roll up and down. During the operation, the non-stay-cord venetian blind keeps horizontal and does not tilts. The bottom beam does not slide down or bounce back in any positions. The winding device adopts a unique structure, which is able to be applied on blinds adopt strip or string shaped ladder tape or blinds with center holes, side holes or side slots on the slats. Multiple cords are able to be winded the same winding drum.

### BRIEF DESCRIPTION OF THE DRAWINGS

FIG. 1 is a perspective view of a structure of a non-stay-cord venetian blind referring to an embodiment 1;

FIG. 2 is a perspective view of an assembled non-stay-cord venetian blind referring to the embodiment 1;

FIG. 3 is a perspective view of an inside structure of a top beam of the non-stay-cord venetian blind referring to the embodiment 1;

FIG. 4 is a perspective view of a dissembled winding device for the non-stay-cord venetian blind referring to the embodiment 1;

FIG. 5 is a perspective view of an assembled winding device for the non-stay-cord venetian blind referring to the embodiment 1;

FIG. 6 is a perspective view of a dissembled motor for the non-stay-cord venetian blind referring to the embodiment 1;

FIG. 7 is a perspective view of an assembled motor for the non-stay-cord venetian blind referring to the embodiment 1;

FIG. 8 is perspective view of a non-stay-cord venetian blind referring to an embodiment 2;

FIG. 9 is perspective view of a non-stay-cord venetian blind referring to an embodiment 3.

Elements number: 1. top beam; 2. bottom beam; 3. cords; 4. slat; 5. shaft; 6. motor; 61. first side shell; 62. second side shell; 63. first clipper set; 64. second clipper set; 65. spiral spring; 650. clamping hook; 67. small roller; 68. big roller; 69. fixing bracket; 690 shell connection part; 7. winding device; 71. winding drum; 710. winding drum cavity; 711. center shaft; 72. fixer; 73. fixing seat; 730. cord center hole; 74. iron core; 75. center one-way shaft; 750. rail for restricting steel ball sliding; 76. clamping spring; 760. stop clamp; 77. rear cover; 78. winding device mounting frame; 8. ladder tape.

### DETAILED DESCRIPTION OF THE PREFERRED EMBODIMENT

Referring to the drawings, according to preferred embodiments of the present invention is illustrated. The terminologies such as the first and the second are not for limiting the number of the corresponding technology features but for distinguishing the related technology features.

### Embodiment 1

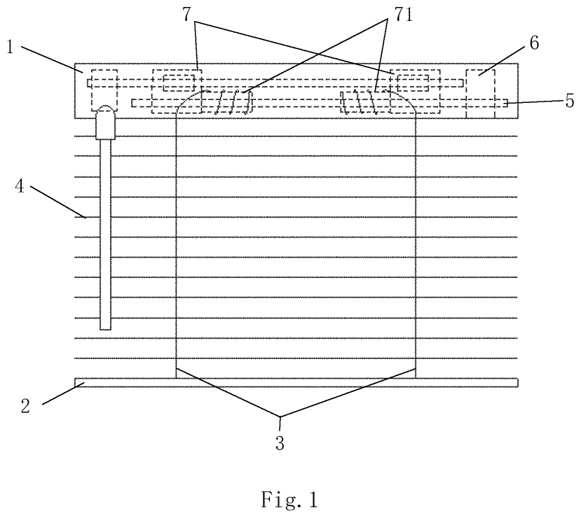

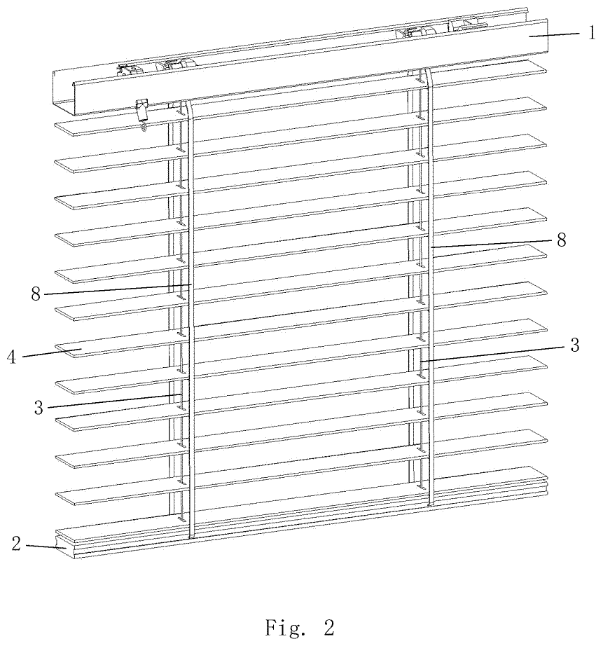

The embodiment 1 is a preferred embodiment of the present invention. As illustrated in the FIG. 1 and FIG. 2, the non-stay-cord venetian blind comprises a top beam 1, a bottom beam 2, slats 4, cords 3, a winding device 7, a motor 6 and a shaft 5. The cords 3 in the embodiment is installed inside the non-stay-cord venetian blind except explained otherwise.

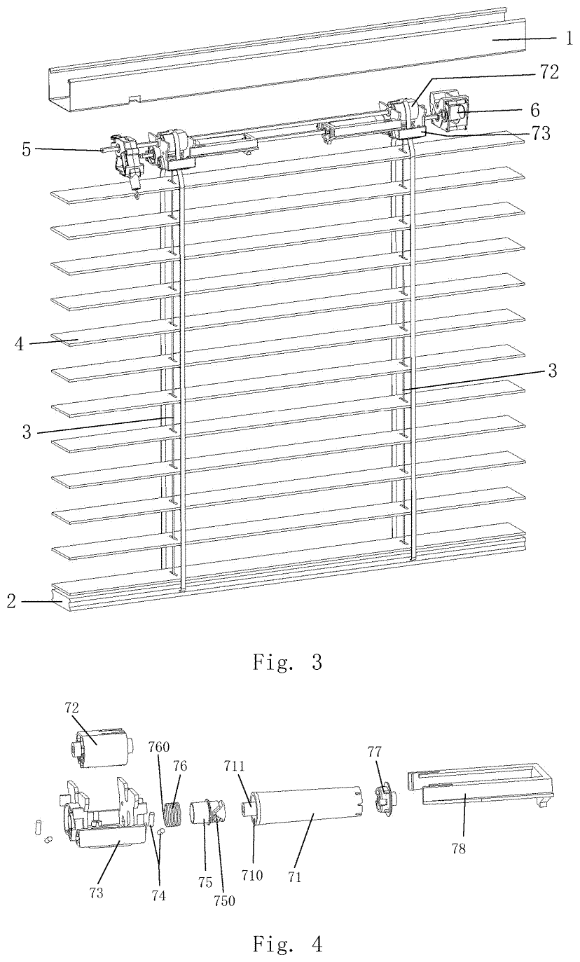

As illustrated in the FIG. 3, the winding device 7 comprises a fixing seat 73, a fixer 72, iron cores 74, a clamping spring 76, a center one-way shaft 75, steel balls, winding drums 71 and rear cover 77.

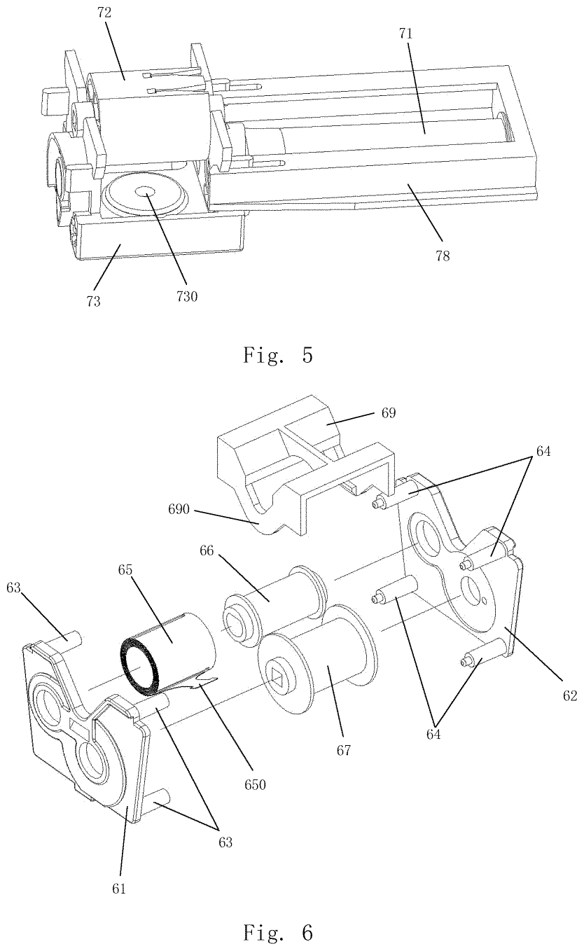

As illustrated in the FIG. 4 and FIG. 5, parts of the winding device 7 are connected in the following way: there are cords holes on two side of the fixing seat 73, wherein the iron cores 74 are clamped in the fixing slot of the cords holes; the clamping spring 76 is put on and tightly fitted with the center one-way shaft 75, wherein the tight fit tightens the connection between the clamping spring 76 and the center one-way shaft 75 and avoids a disconnection; at one end of the clamping spring 76 there is a stop clamp 760 which is clamped in the clamping spring stop clamp slot on the fixing seat 73; the center one-way shaft 75 is put on the winding drum cavities 710 on the first end of the winding drum 71, which is clearance fitted with the winding drum 71 and is able to rotate freely when the clamping spring 76 and the steel balls are not mounted; a rail for restricting the steel ball sliding 750 is on the surface of the center one-way shaft 75; there is a sliding rail on the winding drum cavities 710; the steel balls are between the center one-way shaft 75 and the winding drum cavities 710; the clearance between the rail for restricting the steel ball sliding 750 on the center one-way shaft 75 and the sliding rail on the winding drum is the space for the steel balls to roll; the fixer 72 comprises slots for ladder tapes 8, wherein the fixer 72 is mounted in the fixing seat 73.

The non-stay-cord venetian blind in the embodiment 1 further comprises a winding device mounting frame 78; wherein the winding device 7 is mounted on the shaft though the winding device mounting frame 78.

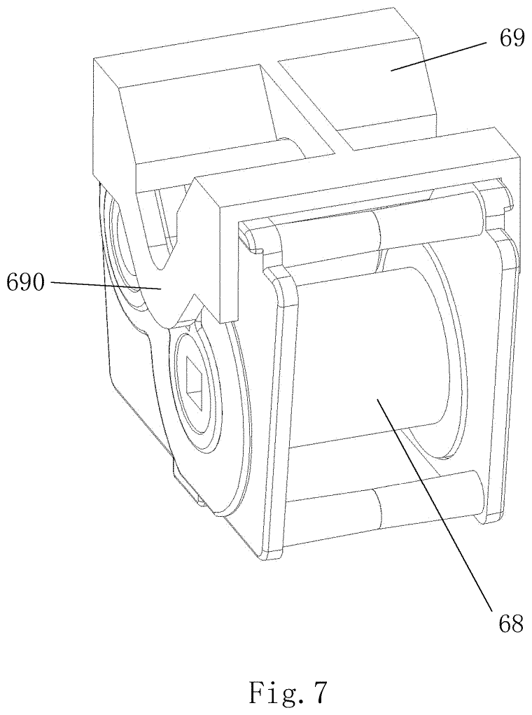

In the embodiment 1, as illustrated in the FIG. 6 and FIG. 7, the motor 6 comprises a shell, a fixing bracket, a spiral spring 65, a small roller 67, a big roller and etc.; wherein all parts of the motor are connected in the following way: the spiral spring 65 is put on the small roller 67, the a clamping hook 650 is on an outer end of the spiral spring 65; the clamping hook 650 is clamped and fixed inside the spiral spring slot on the big roller 68; the big roller and the small roller are fixed and rotates in the shell; the fixing bracket 69 limits and fixes the shell on the two side of the motor 6.

The non-stay-cord venetian blind is assembled in the following way: a first end of the cords 3 is fixed on a end of each of the winding drums 71 near the rear cover 77; a second end of the cords 3 crosses and passes through the iron cores 74 on a side of the fixing seat 73 before passes through the cord center hole 730 on the bottom of the fixing seat 73 and all the slats 4; the cords are fixed on the bottom beam 2; the winding device is connected to the motor 6 by the shaft 5 which enables a synchronized rotation of all rollers; the spiral spring 65 between the big roller 68 and the small roller 67 is in a S shape; the small roller 67 keeps the spiral spring 65 while the non-stay-cord venetian blind is rolling up; the big roller 68 keeps the spiral spring 65 while the non-stay-cord venetian blind is rolling down. The steel balls are between the center one-way shaft 75 and the winding drum cavities 750; wherein movements of the steel balls are limited within an area formed by the rail for restricting the steel ball sliding 750 on the surface of the center one-way shaft 75 and the winding drum cavities 710. The steel balls, center one-way shaft 75 and the winding drum 710 constitute the one-way clutch damper; wherein when the venetian blind is rolled up under the external force, the winding drum 71 drive the steel balls to slide on the rail for restricting the steel ball sliding 750, which enables the winding drum to rotate independently of the center one-way shaft; wherein the bottom beam 2 stops in any position when there is no external force wherein the weight of the bottom beam 2 and the slats 4 drag the venetian blind downward and the venetian blind tends to roll down; the winding drum 71 tends to rotates downward with the steel balls which are not able to slide in the rail for restricting the steel ball sliding; the winding drum 71, the steel balls and the center one-way shaft 75 tend to rotate together; the resistance of the clamping spring stops the center one-way shaft 75 from rotating, which keeps the venetian blind remains still; under the external force, the steel balls in the winding drum 71 overcome the resistance of the clamping spring and drive the center one-way shaft 75 to rotate, which rolls down the venetian blind smoothly.

The external force is applied on the bottom beam 2 to enable the venetian blind to roll up and down smoothly. When there is no external force, the venetian blind stops in any position without rolling up or down. The system fulfills the following conditions: 1. when an external force is applied on the venetian blind, the steel balls enables the winding drum to rotate independently; wherein the clamping spring 76 does not work; the weight of the bottom beam 2 and the slats which drag the cords are removed by the external force; the unwinding force of the spiral spring 65 generates a twisting force which overcomes the weight of the cords 3, wherein the cords 3 wind on the winding drum 71, which enables a smooth roll up of the venetian blind. 2. When the venetian blind is rolled down under the external force, the steel balls enable the winding drum 71, steel balls and the center one-way shaft 75 to rotate together and overcome the resistance (f1) generated by the clamping spring 76 and the unwinding force (f2) of the spiral spring 65, which unwinds the cords 3 from the winding drum 71 to roll down the venetian blind; the forces fulfill F+G>f1+f2 (G is a sum of the weight of the bottom beam 2 and the slats folded on the bottom beam 2). 3. When there is no external force, the venetian blind remains in any positions without rolling down or up; wherein the weight of the bottom beam 2 and the weight of the slats 4 folded on the bottom beam are applied on the cords 3; the venetian blind tends to roll down; the cords 3 drags the winding drum 71; the steel balls enable the winding drum 71, steel balls and the center one-way shaft 75 have a tendency to rotate together; the resistance (f1) of the clamping spring 76 and the unwinding force (f2) of the spiral spring stop the rotation and keep the venetian blind in balance; the venetian blind is able to stop in any position; the forces fulfill G=f1+f2 (G is a sum of the weight of the bottom beam 2 and the slats folded on the bottom beam 2).

The working principal of the non-stay-cord venetian blind is as follow.

When the external force pulls the bottom beam 2 and the venetian blind rolls down, the cords 3 is pulled out from the cord gear of the cord keeping system; the left cord gear and the transition gear in the cord keeping system rotate clockwise while the spring gear and the right cord gear rotate counter clockwise; the spiral spring 65 is winded by the spring gear and keeps winding on the spring gear; the sum of the external force, the weight of the bottom beam 2 and the weight of the slats 4 folded on the bottom beam 2 is bigger than the sum of the unwinding force of the cord keeping system and the frictions of the cords inside the fixing seat 73, which enables the venetian blind to roll down smoothly.

When external force pushes the bottom beam 2 upwards to roll up the venetian blind, the unwinding force of the spiral spring 65 of the cord keeping system drives the left cord gear and the transition gear to rotate counter clockwise and the spring gear and the right cord gear to rotate clockwise, which draws back the cords 3 into the cords gear; the external force pushes the bottom beam 2 upwards, wherein the resistance of the of the cords 3 is the only the cord friction generated by the fixing seat 73; the unwinding force of the spiral spring 65 is bigger than the cord friction generated by the fixing seat 73, which enables the venetian blind to roll up smoothly.

When there is no external force and the venetian blind is completely rolled up, the slats 4 are folded on the bottom beam 2; wherein the sum of the weight of the bottom beam 2 and the weight of the slats 4 is smaller or equals the sum of the cord friction of the cords (3) in the fixing seat 73 and the unwinding force of the spiral spring 65 of the cord keeping system, which prevents the venetian blind from rolling down.

When there is no external force and the venetian blind is completely rolled down, the slats 4 spread completely; wherein the sum of the weight of the top beam 1 and the cord friction in the fixing seat 73 is bigger or equals the unwinding force of the spiral spring 65 in the cord keeping system, which prevents the venetian blind from bounce back.

In the embodiment 1, as illustrated in the FIG. 10, the winding device 7 comprises two sets of fixing seats 73, two sets of fixers 72, two sets of one-way clutch dampers, two sets of the clamping springs 76 and two sets of the winding drums 71, which are mounted on the two sides of the shaft 5. The center holes are punched on the slats 4 corresponding to the cord center holes 730 on the fixing seat 73; wherein there are two center holes on the each of the slats 4. The fixing seat 73, the fixer 72, the one-way clutch damper and the clamping spring 76 on each side of the shaft coordinate with one of the cords 3; wherein there are two cords 3 in the embodiment 1, which pass through the center holes on the slats 4 respectively; wherein a first end of the cords is fixed on a end of each of the winding drums near the rear cover 77; a second end of the cords crosses and passes through the iron cores 74 on a side of the fixing seat 73 before passes through the cord center hole 730 on the bottom of the fixing seat 73 and all the slats 4; the cords are fixed on the bottom beam 2.

### Embodiment 2

The embodiment 2 provides a non-stay-cord venetian blind which comprises a top beam 1, a bottom beam 2, slats 4, cords 3, a winding device 7, a motor 6 and a shaft 5. The cords 3 in the embodiment 2 is installed inside the non-stay-cord venetian blind except explained otherwise. The embodiment 2 does not comprise cords outside of the whole venetian blind.

The winding device 7 comprises the fixing seat 73, the fixer 72, the winding drum 71, the rear cover 77, the iron cores 74, the clamping spring 76, the center one-way shaft 75 and steel balls, wherein the steel balls, center one-way shaft 75 and the winding drum 71 constitute the one-way clutch damper which controls the venetian blind to roll down, roll up and keep still in a certain position. A first end of the clamping spring is tight fitted on a center one-way shaft 75; a stop clamp 760 is on a second end of the clamping spring 76; on the fixing seat 73 there is a groove for the stop clamp; the clamping spring 76 and the stop clamp 760 are clamped and fixed in the groove. When there is no external force applied on the venetian blind, the weight of the bottom beam 2 and the slats 4 drag the venetian blind downward. The resistance of the clamping spring 76 overcomes the gravity and stops the rotation of the center one-way shaft 75. The venetian blind remains still. The center one-way shaft 75 is put on a first end of each of winding drum cavities 710; wherein the center one-way shaft 75 is clearance fitted with the winding drum cavities 710. On the surface of the center one-way shaft 75 there is a rail for restricting a steel ball sliding 710. There is a sliding rail on the winding drum cavities 710. A first end of the winding drum 71 comprises the center shaft 711. The sliding rail is set between the center shaft 711 and the inner wall of the winding drum cavities 710. The center one-way shaft 75 is mounted on the center shaft 711 inside the winding drum cavities 710. The clearance between the center one-way shaft and the sliding rail on the winding drum is the space for the steel balls to roll. The second end of the winding drum is connected to the rear cover. On the surface of the center one-way shaft 75 there is a rail for restricting a steel ball sliding 750; wherein there is a sliding rail on the winding drum cavities 710; steel balls are between the center one-way shaft 75 and the winding drum cavities 710. movements of the steel balls are limited within an area formed by the rail for restricting the steel ball sliding 750 on the surface of the center one-way shaft 75 and the winding drum cavities 710. The steel balls, center one-way shaft and the winding drum constitute the one-way clutch damper. When the venetian blind is rolled up under the external force, the winding drum 71 drive the steel balls to slide on the rail for restricting the steel ball sliding 750, which enables the winding drum to rotate independently of the center one-way shaft 75. The bottom beam 2 stops in any position when there is no external force. The weight of the bottom beam 2 and the slats 4 drag the venetian blind downward and the venetian blind tends to roll down. The winding drum 71 tends to rotates downward with the steel balls which are not able to slide in the rail for restricting the steel ball sliding. The winding drum 71, the steel balls and the center one-way shaft 75 tend to rotate together. The resistance of the clamping spring 76 stops the center one-way shaft 75 from rotating, which keeps the venetian blind remains still. Under the external force, the steel balls in the winding drum 71 overcome the resistance of the clamping spring 76 and drive the center one-way shaft 75 to rotate, which rolls down the venetian blind smoothly. The rail for restricting the steel ball sliding 750 is preferably a rail distributed on the surface of the center one-way shaft, which is preferably a groove or a through hole. On the fixing seat 73 there are a cord center hole 730, ladder tape holes and a fixing slot for the iron cores. The cord center hole 730 is on the center of the bottom of the fixing seat 73 and passes through the bottom of the fixing seat. The ladder tape holes are on the two sides of the cord center holes 730 and passes through the bottom of the fixing seat 73. The ladder tape holes are for the ladder tape 8 to pass through. Preferably, there are two ladder tape holes through which the ladder tapes 8 or the cords 3 passes through. Two cords 3 are able to pass through the ladder tape holes when the cords 3 are distributed on the two sides of the slat 4. The ladder tape holes are in a strip shape, which are suitable for the strip-shaped ladder tape and the string-shaped ladder tape. The ladder tape holes are suitable for both the wide ladder tape and the narrow ladder tape. On two sides of the fixing seat 73 there are cord holes on which the iron cores are located. The iron cores are mounted in the fixing slot to damp the system. There are two iron cores and two fixing slots on each side of fixing seat 73. The iron cores 74 are mounted in the fixing slot, which is also for the winding and mounting of the cords.

In the embodiment 2, the motor 6 comprises the shell, the spiral spring 65 and the rollers. The rollers comprise the big rollers 68 and the small rollers 67. On the big roller 68 there is a spiral spring slot. The spiral spring 65 is put on the small roller 67. A clamping hook 650 is on an outer end of the spiral spring 65, which is clamped and fixed inside the spiral spring slot. The spiral spring 65 between the big roller 68 and the small roller 67 is in a S shape. The spiral spring 65 is coiled inside the small roller 67 while the venetian blind rolling up and the spiral spring 65 is coiled inside the big roller 68 while the venetian blind rolling down. The shell comprises a first side shell 61 and a second side shell 62; wherein on the first side shell 61 there are roller slots for the spiral spring 65 and the big roller 68 and a first clipper set 63 for the second side shell 62; on the second side shell 62 there are roller slots for the small roller 67 and the big roller 68 and a second clipper set 64 for the first side shell 61. The first clipper set matches the second clipper set, which assembles the first side shell 61 and the second side shell 62. The motor 6 further comprises a fixing bracket 69 which comprises a shell connection part 690. The fixing bracket fixes and integrates the spiral spring 65, the rollers and the shell. The shell connection part 690 is connected to and assembled with the first side shell 61 and/or the second side shell 62 by clippers. The clippers connect and fix the fixing bracket 69 and the shell. On the shell connection part 690 there are dents or convexes match the first side shell 61 and/or the second side shell 62. The dents or convexes are for connecting and fixing the fixing bracket 69 and the shell. On the first side shell 61 and/or the second side shell 62 there are dents or convexes match the shell connection part 690. The dents or convexes are for connecting and fixing the fixing bracket 69 and the shell. The cords 3 are installed inside the non-stay-cord venetian blind. Holes are punched on the slats 4, through which the cords 3 pass.

A first end of the cords 3 is fixed on a end of each of the winding drums 71 near the rear cover 77; wherein a second end of the cords 3 crosses and passes through the iron cores 74 on a side of the fixing seat 73 before passes through the cord center hole 730 on the bottom of the fixing seat 73 and all the slats 4; the cords are fixed on the bottom beam 2; the winding device is connected to the motor 6 by the shaft 5 which enables a synchronized rotation of all rollers.

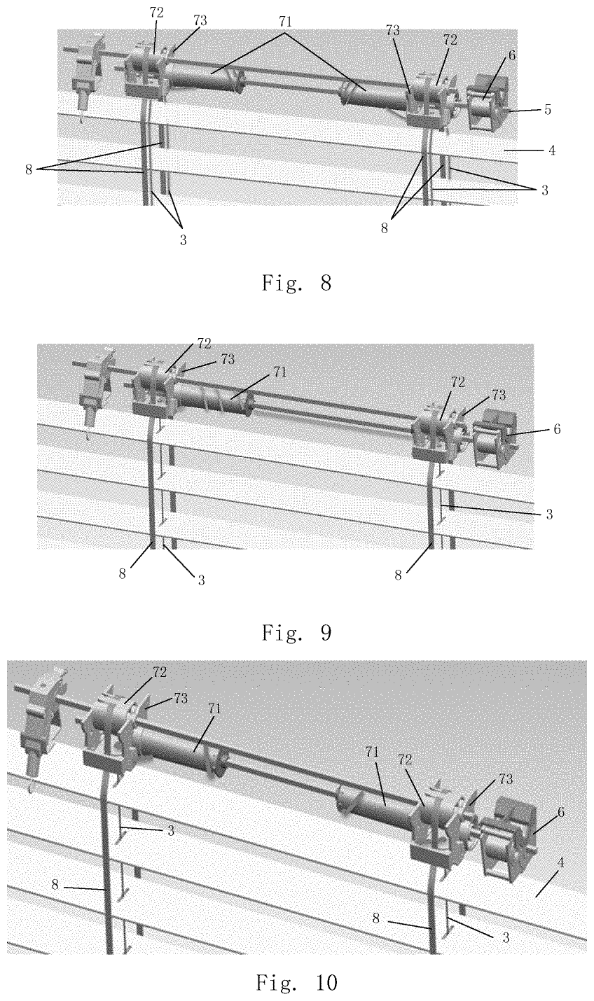

In the embodiment 2, as illustrated in the FIG. 8, the winding device 7 comprises two sets of fixing seats 73, two sets of fixers 72, two sets of one-way clutch dampers, two sets of the clamping springs 76 and two sets of the winding drums 71, which are mounted on the two sides of the shaft 5. The side holes are punched on the slats 4 corresponding to the ladder holes on the fixing seat 73. The cords 3 each side of the shaft is winded and fixed on the winding drum 71 of the same side. The cords 3 on each side of the shaft 5 thread in the venetian blind in the following way. A first end of the cords 3 is fixed on a end of each of the winding drums 71 near the rear cover 77; a second end of the cords 3 crosses and passes through the iron cores 74 on a side of the fixing seat 73 before passes through the ladder tape holes on one side of the fixing seat 73 and the side holes of all the slats 4; the cords are fixed on the bottom beam 2. The first end of the cords 3 on the other side of shaft is fixed on a end of each of the winding drums 71 near the rear cover 77; a second end of the cords 3 crosses and passes through the iron cores 74 on the other side of the fixing seat 73 before passes through the ladder tape holes on the other side of the fixing seat 73 and the side holes of all the slats 4 on the other side; the cords 3 are fixed on the bottom beam 2. The cords 3 pass through the side holes on two sides of the slats 4 before passing through the ladder holes on the fixing seat 73. There are two cords 3 inside the winding drum 71. The winding device 7 on the other side of the shaft also comprises two cords 3. The cords 3, slats 4 and the winding device 7 are thus assembled.

Another settlement of cord 3 is able to be adopted by the embodiment 2. wherein the winding device on each side of the shaft 5 coordinates with one cord 3; the first end of the cords 3 is fixed on a end of each of the winding drums 71 near the rear cover 77; a second end of the cords 3 crosses and passes through the iron cores 74 on the fixing seat 73 before passes through the ladder tape holes on one side of the fixing seat 73 and the side holes on one side of the slats 4; the cords 3 pass the through holes on the bottom beam before passing the side holes on the other side of the slats in a reversed direction before passing the ladder tape holes on the other side of the fixing seat; then the cords cross and pass through the iron cores 74 on the fixing seat 73; finally the other end of the cords 3 is also fixed on the winding drum 71; both ends of the cords 3 are fixed on the winding drum 71.

### Embodiment 3

The embodiment 3 is similar to the embodiment 1 or 2 with a difference in that the winding device 7 of the embodiment 3 comprises two sets of fixing seats 73, two sets of fixer 72 and one set of one-way clutch damper, a clamping spring 76 and a winding drum 7. As illustrated in the FIG. 9, the two sets fixing seats and fixer are mounted on two sides of the top beam respectively. The one-way clutch damper and the clamping spring 76 coordinate and are assembled with one of the two sets of the fixing seats 73 and one of the two sets of the fixers 72. One end of each of the cords 3 is fixed on one end of the same winding drum 71 near the rear cover 77. Two cords 3 are mounted inside the winding drum 71; wherein the two cords 3 are fixed and winded on the winding drum 71 before passing through the center holes of the slats 4 and being fixed on the bottom beam 2. The cords 3 are winded in the fixing seat 73 in a way similar to the embodiment 1 and the embodiment 2.

### Embodiment 4

The embodiment 4 is similar to the embodiment 1 with a difference in that the clamping spring in the one-way clutch damper is replaced with a sleeve structure which is tightly fitted on one end of the center one-way shaft. When the venetian blind is rolled down or up, the resistance between the sleeve structure and the tight fit generates the damping of the one-way clutch damper. The working principal of the damping controlling the venetian blind is similar to the embodiment 1, which requires no more explanation.

### Embodiment 5

Embodiment 5 is similar to the embodiment 4 with a difference in that the one-way clutch damper adopts a rubber damping. The resilient rubber is a preferred choice. The rubber has special rigidity and resilience which enables the one-way clutch damper to damp the system. One end of the resilient rubber is tightly fitted on the center one-way shaft and the other end of the resilient rubber is fixed on and connected to the fixing seat. Clippers and slots are set on the fixing seat for connecting and fixing the resilient rubber. The replacement of the rubber damping with a plastic damping or a damping tape is also within the scope of the present invention.

### Embodiment 6

Embodiment 6 is similar to embodiment 4 with a difference in that the sleeve structure adopts rubber or plastic. The resilient rubber is a preferred choice. The rubber has special rigidity and resilience which enables the one-way clutch damper to damp the system. Larger friction is generated when the rubber sleeve structure is tightly fitted with the center one-way shaft, which improves the stability of the mounting.

The present invention provides a new fixing seat structure for the non-stay-cord venetian blind. The friction of the cords keeps the venetian blind stay still in different positions and prevents the venetian blind from sliding down or bounce back.

1: A winding device for a non-stay-cord venetian blind, comprising: a fixing seat (73), a fixer (72), winding drums (71), a rear cover (77) and iron cores (74), wherein each of the winding drums comprises a one-way clutch damper.

2: The winding device, as recited in claim 1, wherein the one-way clutch damper damps in a way selected from a group consisting of a rubber damping, a plastic damping, a damping tape, a spring and a tight fit.

3: The winding device, as recited in claim 1, further comprising a clamping spring (76), a center one-way shaft (75) and steel balls; wherein the one-way clutch damper comprises the steel balls, the center one-way shaft (75) and the clamping spring (76); wherein a first end of the clamping spring (76) is tight fitted on a center one-way shaft (75); a stop clamp (760) is on a second end of the clamping spring (76); there is a groove for the stop clamp on the fixing seat (73); the clamping spring (76) and the stop clamp (760) are clamped in the groove wherein the center one-way shaft (75) is put on a first end of each of winding drum cavities (710); the center one-way shaft (75) is clearance fit with the winding drum cavities (710); wherein there is a rail for restricting a steel ball sliding (750) on a surface of the center one-way shaft (75); there is a sliding rail on the winding drum cavities (710); steel balls are between the center one-way shaft (75) and the winding drum cavities (710); movements of the steel balls are limited within an area formed by the rail for restricting the steel ball sliding (750) on the surface of the center one-way shaft (75) and the winding drum cavities (710); wherein there are a cord center hole (730), ladder tape holes and a fixing slot for the iron cores on the fixing seat; wherein the cord center hole (730) is on a center of a bottom of the fixing seat (73), which passes through the fixing seat (73); wherein the ladder tape holes are set on two sides of the cord center hole (730) on the bottom of the fixing seat (73), which pass through the fixing seat (73); wherein the ladder tape holes are in a strip shape: wherein there are cord holes on which the iron cores are located on two sides of the fixing seat (73).

4-11. (canceled)

12: A non-stay-cord venetian blind, comprising a top beam (1), a bottom beam (2), slats (4), cords (3), winding devices, a motor (6) and a shaft (5); wherein the winding device is recited in claim 1; wherein the motor (6) comprises a shell, a spiral spring (65) and rollers; wherein the rollers comprise a big roller (68) and a small roller (67); wherein the shell comprises a first side shell (61) and a second side shell (62); there are roller slots or through holes for the small roller (67) and the big roller (68) and a first clipper set (63) for the second side shell (62) on the first side shell; there are roller slots or through holes for the small roller (67) and the big roller (68) and a second clipper set (64) for the first side shell (61) on the second side shell; wherein there is a spiral spring slot on a roller slot for the big roller; a clamping hook (650) is on an outer end of the spiral spring (65); the spiral spring (65) is put on the small roller (67); the clamping hook (650) is clamped and fixed inside the spiral spring slot; wherein the spiral spring (65) between the big roller (68) and the small roller (67) is in an S shape; the small roller (67) keeps the spiral spring (65) while the non-stay-cord venetian blind is rolling up; the big roller (68) keeps the spiral spring (65) while the non-stay-cord venetian blind is rolling down; wherein the motor (6) further comprises a fixing bracket (69) which comprises a shell connection part (690); wherein the shell connection part (690) is connected to and assembled with the first side shell (61) and/or the second side shell (62) by clippers; wherein there are dents or convexes match the first side shell (61) and/or the second side shell (62) on the shell connection part (690); wherein there are dents or convexes match the shell connection part (690) on the first side shell (61) and/or the second side shell (62); wherein the cords (3) are installed inside the non-stay-cord venetian blind; wherein a first end of the cords is fixed on an end of each of the winding drums near the rear cover (77); a second end of the cords crosses and passes through iron cores (74) on a side of the fixing seat (73) before passes through a cord center hole (730) on the bottom of the fixing seat (73) and all the slats (4); the cords are fixed on the bottom beam (2); the winding device is connected to the motor (6) by the shaft (5) which enables a synchronized rotation of all the rollers wherein center holes are punched on the slats (4), through which the cords pass; wherein there are two cords which are winded and fixed on the winding drums; wherein there are two center holes on each of the slats; there are two winding drums corresponding to the two center holes on each of the slats; there are two cords and each of the cords passes through the center holes on the slats before being winded and fixed on a winding drum on a same side; wherein side slots or side holes are punched on the slats; wherein the cords pass through the side slots or the side holes on the slats; wherein there are at least two cords; wherein there are two winding drums corresponding to the side slots or the side holes each of the cords passes through the side slots or the side holes before is winded and fixed on a winding drum on a same side.

13-29. (canceled)

30: The non-stay-cord venetian blind, as recited in claim 12, having no cords outside of the non-stay-cord venetian blind.

31: A non-stay-cord venetian blind, comprising a top beam (1), a bottom beam (2), slats (4), cords (3), winding devices, a motor (6) and a shaft (5); wherein the winding device is recited in claim 2.

32: The non-stay-cord venetian blind, as recited in claim 4, wherein the cords (3) are installed inside the non-stay-cord venetian blind.
